(19) United States
(12) Patent Application Publication
(10) Pub. No.: US 2020/0083767 A1
(43) Pub. Date: Mar. 12, 2020

(54) PERMANENT MAGNET MOTOR

(71) Applicant: ADLEE POWERTRONIC CO., LTD., Taichung City (TW)

(72) Inventor: Shou-Yu CHU, Taichung City (TW)

(21) Appl. No.: 16/123,533

(22) Filed: Sep. 6, 2018

(51) Int. Cl. H02K 1/27; H02K 1/16

(52) U.S. Cl. CPC H02K 1/2766; H02K 1/165

(57) ABSTRACT

A permanent magnet motor is provided, including: a stator and a rotor. The stator has a plurality of windings. The rotor has a plurality of magnet placement slots and a plurality of air gaps. The plurality of magnet placement slots includes a plurality of circumferential magnet placement slots circumferentially arranged and a plurality of radial magnet placement slots radially extending. The circumferential magnet placement slots and the radial magnet placement slots are circumferentially alternately arranged. The plurality of air gaps are adjacent to part of the plurality of magnet placement slots and distributed to be on a d-axis flux path of the rotor.

### BACKGROUND OF THE INVENTION

### Field of the Invention

The present invention relates to a permanent magnet motor.

### Description of the Prior Art

Generally, a number, positions or arrangement angles of magnets in a rotor are adjusted to reach desired characteristics, such as different speeds, loads or performances. Taiwan patent number 129116 discloses that a configuration of the magnets is changeable. However, a radial magnet only provides a magnetic field for single magnetic pole, which results in requirement of two of radial magnets disposed between two adjacent magnetic poles. Therefore, more magnets are needed and the cost is increased, and a magnetic pole included angle is decreased due to an interval between the two radial magnets, which results in low output.

U.S. Pat. No. 8,044,548 discloses that a rotor includes a plurality of circumferential and radial magnet placement slots, and each of the plurality of circumferential and radial magnet placement slots receives a magnet. Magnetic flux density and magnetizing direction on the d-axis and q-axis may be defined by placing the magnets with different materials in the circumferential and radial magnet placement slots. In addition, the rotor described in the patent may have air gaps. However, the air gaps described in the patent cannot cooperate well with both the d-axis and the q-axis flux path, and the q-axis flux path is blocked, which is unable to obtain preferable speed and torque at the same time.

The present invention is, therefore, arisen to obviate or at least mitigate the above-mentioned disadvantages.

### SUMMARY OF THE INVENTION

The main object of the present invention is to provide a permanent magnet motor whose flux path is plannable to obtain expected performance.

To achieve the above and other objects, the present invention provides a permanent magnet motor, including: a stator and a rotor. The stator has a plurality of windings. The rotor has a plurality of magnet placement slots and a plurality of air gaps. The plurality of magnet placement slots include a plurality of circumferential magnet placement slots circumferentially arranged and a plurality of radial magnet placement slots radially extending. The circumferential magnet placement slots and the radial magnet placement slots are circumferentially alternately arranged. The plurality of air gaps are adjacent to a part of the plurality of magnet placement slots and distributed to be on a d-axis flux path of the rotor.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a schematic diagram of positions of a d-axis and a q-axis;

FIG. 2 is a schematic diagram of a d-axis flux path;

FIG. 3 is a schematic diagram of a q-axis flux path;

FIG. 4 is a schematic diagram when a magnetic axis deviates due to armature reaction;

FIG. 5 is a schematic diagram of a rotor of a preferable embodiment of the present invention;

FIG. 6 is a partial enlargement of FIG. 5;

FIGS. 7 to 11 are schematic diagrams showing different arrangements of magnets in part of magnet placement slots according to a preferable embodiment of the present invention;

FIGS. 12 to 17 are schematic diagrams showing different arrangements with each magnet placement slot receiving a magnet according to a preferable embodiment of the present invention, wherein ends of every adjacent two teeth portions of the stator in FIG. 17 have a larger space therebetween;

FIGS. 18 to 20 are schematic diagrams showing arrangements with second magnet placement slots according to a preferable embodiment of the present invention; and

FIG. 21 is a schematic diagram showing an arrangement with air gaps according to another preferable embodiment of the present invention.

### DETAILED DESCRIPTION OF THE PREFERRED EMBODIMENTS

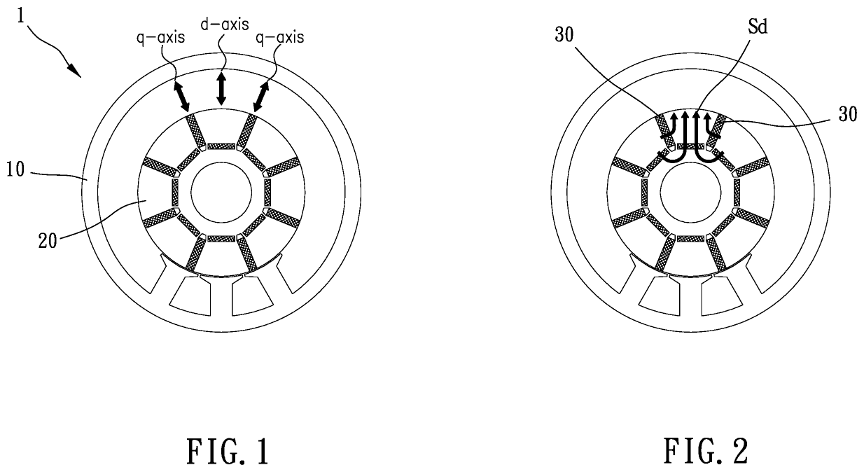

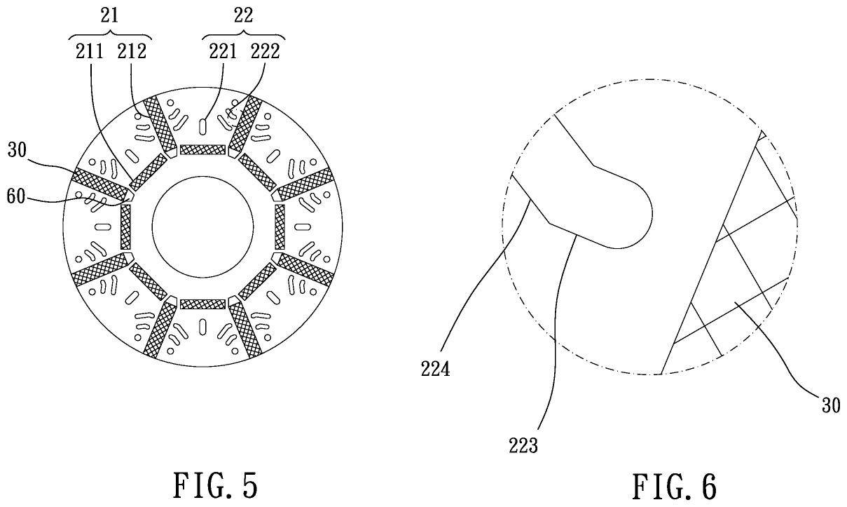

Please refer to FIGS. 1 to 6 for a preferable embodiment of the present invention. A permanent magnet motor 1 of the present invention includes a stator 10 and a rotor 20.

The stator 10 has a plurality of windings 11. The rotor 20 has a plurality of magnet placement slots 21 and a plurality of air gaps 22. The plurality of magnet placement slots 21 include a plurality of circumferential magnet placement slots 211 circumferentially arranged and a plurality of radial magnet placement slots 212 radially extending. The circumferential magnet placement slots 211 and the radial magnet placement slots 212 are circumferentially alternately arranged. The plurality of air gaps 22 are adjacent to part of the magnet placement slots and distributed to be on a d-axis flux path Sd of the rotor 20. Therefore, the flux path is plannable to obtain expected performance.

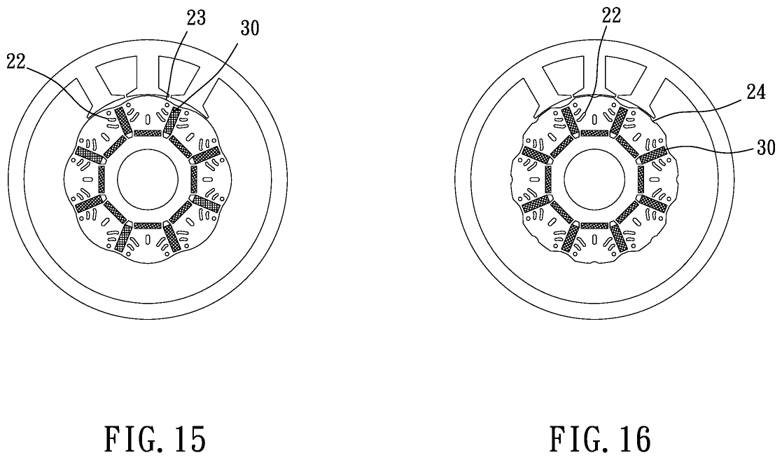

The plurality of magnet placement slots 21 receive a plurality of magnets 30. At least a part of the circumferential magnet placement slots 211 receive a part of the plurality of magnets 30, and at least a part of the plurality of radial magnet placement slots 212 receive a part of the plurality of magnets 30. In this embodiment, each of the magnet placement slots receives one of the magnets 30, which has high efficiency and high output and is smooth and stable in operation. However, the arrangement of the magnets may be optionally changed according to various requirements. As shown in FIGS. 7 and 8, a part or all of the plurality circumferential magnet placement slots 211 receive magnets, and the plurality of radial magnet placement slots 212 are empty so as to obtain a higher rotating speed. As shown in FIGS. 9 and 10, a part or all of the plurality of radial magnet placement slots 212 receive a plurality of magnets, and the plurality of circumferential magnet placement slots 211 are empty so as to obtain a higher rotating speed. As shown in FIG. 11, a part of the plurality of radial magnet placement slots 212 receive a plurality of magnets, and a part of the plurality of circumferential magnet placement slots 211 receive a plurality of magnets so as to minimize armature reaction of an unidirectionally-rotary motor. The plurality of radial magnet placement slots 212 may, in a serial occupied-empty manner, receive magnets, and each of the plurality of circumferential magnet placement slots 211 receives one of the magnets. All of the magnet placement slots may be empty, to form a reluctance motor. The plurality of magnets may be plannably arranged to have different pole number in the manufacturing process. Taking FIG. 8 as an example, the magnets 30 received in the plurality of circumferential magnet placement slots 211 may be configured in a N-S-N-S . . . manner to form eight poles or be configured in a N-N-S-S . . . manner to form four poles. The configuration as shown in FIG. 9 may be plannably changed to include eight poles or four poles. A number of the poles of the magnets can be plannably changed as a number of the plurality of circumferential magnet placement slots 211 is a multiple of four. Preferably, the radial magnet placement slots 212 which are empty may further receive permeability materials under a four-pole condition for flux continuity and preferable output performance.

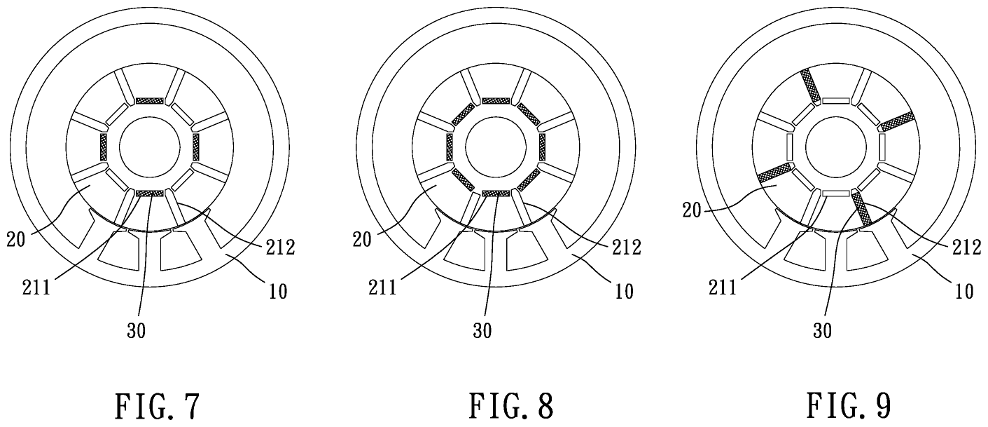

A magnetic flux centeral axis 40 of the permanent magnet motor is located on a magnetic pole centeral axis 50 as there is no armature reaction. After the windings 11 of the stator 10 are electrified, a magnetic field is generated to interact with a magnetic field of the plurality of magnets 30, and a new magnetic flux centeral axis 40 which deviates from the magnetic pole centeral axis 50 is produced due to the armature reaction (FIG. 4). A deviation of the magnetic flux centeral axis 40 may result in low effective magnetic flux and low output performance. The plurality of air gaps 22 can provide reluctance so as to reduce the deviation of the magnetic flux centeral axis 40 relative to the magnetic pole centeral axis 50 caused by the armature reaction. The armature reaction can be effectively reduced.

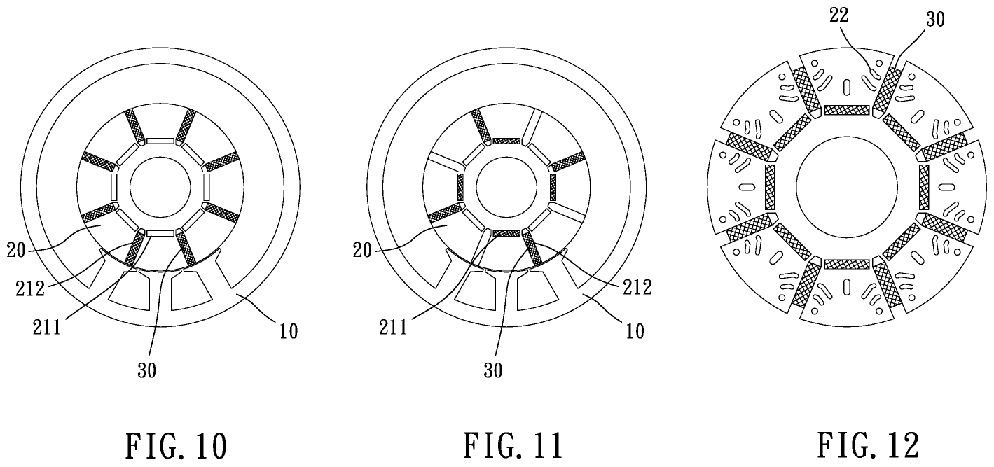

The plurality of magnets 30 preferably are identical in physical characteristic. The physical characteristic includes at least one of material, shape and size. However, the plurality of magnets 30 may be different in the physical characteristic according to various requirements. For example, materials of the plurality of magnets 30 may be the same or different, or shapes of the plurality of magnets 30 may be the same or different. At least one of the plurality of magnets 30 may have a shape different from or the same as a shape of at least one of the plurality of magnet placement slots 21. For example, at least one of the plurality of radial magnet placement slots 212 extends and terminates between two end surfaces, facing each other, of adjacent two of the circumferential magnet placement slots 211. The magnets 30 are cuboids and there are intervals 60 at respective ends of the magnet placement slots 21 after the magnets 30 are placed in the magnet placement slots 21 (as shown in FIG. 5). Preferably, along a circumferential direction of the rotor, the two end surfaces entirely within the radial magnet placement slot 212 between the two end surfaces, and the intervals 60 can reduce magnetic flux leakage.

Relative to an outer periphery of the rotor 20, the plurality of air gaps 22 are arcuately distributed in conformity with a q-axis flux path Sq of the rotor 20 and radially inwardly concave. The plurality of air gaps 22 are distributed arcuately toward the circumferential magnet placement slots 211 so as to retain a part of the q-axis flux path Sq and decrease the armature reaction.

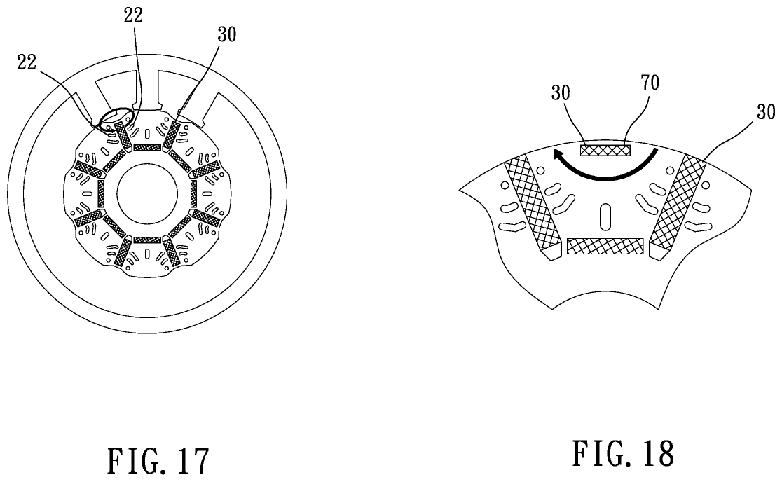

Outer ends of the plurality of magnets 30 are contracted inwardly relative to the outer periphery of the rotor 20 (as shown in FIGS. 12 to 17) so as to decrease the influence of the armature reaction on magnet degaussing. The deviation of the magnetic flux centeral axis 40 relative to the magnetic pole centeral axis 50 caused by the armature reaction may enhance a magnetic field of an end of the magnets 30 radially close to the outer periphery of the rotor 20. If a direction of the enhanced magnetic field is opposite to that of the magnetic poles of the magnets 30 radially arranged, there may be degauss caused to the magnets 30; if the direction of the enhanced magnetic field is the same as that of the magnetic poles of the magnets 30 radially arranged, it may cause magnetic saturation. Both configurations described above can affect distribution of the magnetic flux.

The plurality of windings 11 of the stator 10 are capable of being adjustable for current distribution so as to adjust a ratio of a d-axis flux and a q-axis flux entering the rotor 20. By means of adjustment of the ratio of the d-axis flux and the q-axis flux entering the rotor 20, the deviation of the magnetic flux centeral axis 40 relative to the magnetic pole centeral axis 50 caused by the armature reaction can be adjusted, which means that the effective magnetic flux and the output performance of the permanent magnet motor can be adjusted. For example, the deviation of the magnetic flux centeral axis may be pre-compensated by adjusting current applied to the windings so that the magnetic flux centeral axis 40 overlaps the magnetic pole centeral axis 50, which improves effective magnetic flux and output performance.

The plurality of radial magnet placement slots 212 may be directly open at the outer periphery of the rotor 20 (as shown in FIGS. 1 to 12) so that it is easy to manufacture and place the magnets 30. The magnets 30 radially arranged may also be flush with or retracted inwardly within the radial magnet placement slots 212. The rotor 20 may further include a plurality of rib portions 213 and each of the rib portions 213 is disposed radially next to an outer end of one of the radial magnet placement slots 212 (as shown in FIGS. 13 to 17), or the radial magnet placement slots are non-penetrated through the outer periphery of the rotor so as to increase structural strength of the rotor 20 and prevent the magnets 30 from departing due to centrifugal force. The rib portions 213 may be flush with or retracted inwardly relative to the outer periphery of the rotor 20.

The stator 10 further includes a plurality of teeth portions 12 extending radially, and the plurality of windings 11 are disposed around the plurality of teeth portion 12 respectively. The stator 10 further includes a plurality of stator slots 13 which are configured to receive the plurality of windings 11. Openings of the stator slots 13 may be necked, and a width of each of the openings of the stator slots 13 is in negative proportion to the magnetic flux leakage. As shown in FIGS. 14 and 17, the width of the opening in FIG. 14 is smaller so that the magnetic flux leakage is larger and the magnetic flux is smaller; the width of the opening in FIG. 17 is larger so that the magnetic flux leakage is smaller and the magnetic flux is larger. A magnetic pole included angle A defined by the plurality of magnets 30 between adjacent two of the plurality of radial magnet placement slots 212 is smaller than a magnetic pole angle B defined by two center axes, extending radially, of adjacent two of the plurality of radial magnet placement slots 212. A magnetic flux of each of the magnetic poles may be short-circuited to the adjacent magnetic poles through the teeth portion 12 of the stator 10 and result in magnetic flux leakage. A short-circuit magnetic flux cannot interact with the magnetic flux created by the windings 11 of the stator 10, which results in low effective magnetic flux and low output performance. Therefore, the smaller the magnetic pole included angle A is, the smaller the magnetic flux leakage is.

The outer periphery of the rotor 20 may include one or a plurality of eccentric arc segments (as shown in FIGS. 14 to 17) or straight segments so that air gaps between the rotor 20 and the stator 10 are gradually increased or decreased and flux linkage are gradually increased or decreased, to decrease the cogging torque. Taking FIG. 15 as an example, the outer periphery of the rotor 20 includes a plurality of arc segments 23, and at least one of the plurality of arc segments 23 (preferably all) and the rotor 20 are eccentric. However, the outer periphery of the rotor may include one or a plurality of the arc segments which are concentric.

The outer periphery of the rotor 20 has a retracted surface 24 near a d-axis of the rotor 20 (FIG. 16). The magnetic flux is strongest near the d-axis or the magnetic pole centeral axis 50 on the outer periphery of the rotor 20 where produces lager cogging torque. The retracted surface 24 properly disposed can increase the air gaps to increase the reluctance so as to reduce the cogging torque.

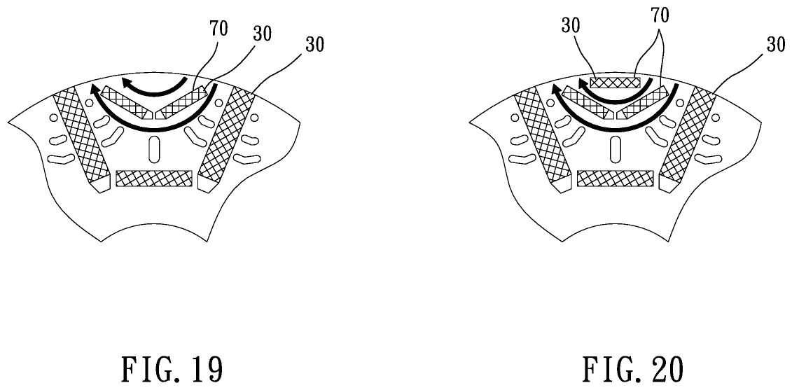

Referring to FIGS. 18 to 20, the rotor 20 further includes a plurality of second magnet placement slots 70 which are disposed between some of adjacent two of the plurality of radial magnet placement slots 212. At least one of the plurality of second magnet placement slots 70 receives at least one of the magnets 30, which can increase flux of the magnetic pole and torque. The second magnet placement slots 70 may be disposed between a part or all of adjacent two of the radial magnet placement slots 212. A part or all of the second magnet placement slots 70 receive the magnets. The plurality of second magnet placement slots 70 may be configured in a single layer (as shown in FIGS. 18 and 19) or multiple layers (as shown in FIG. 20).

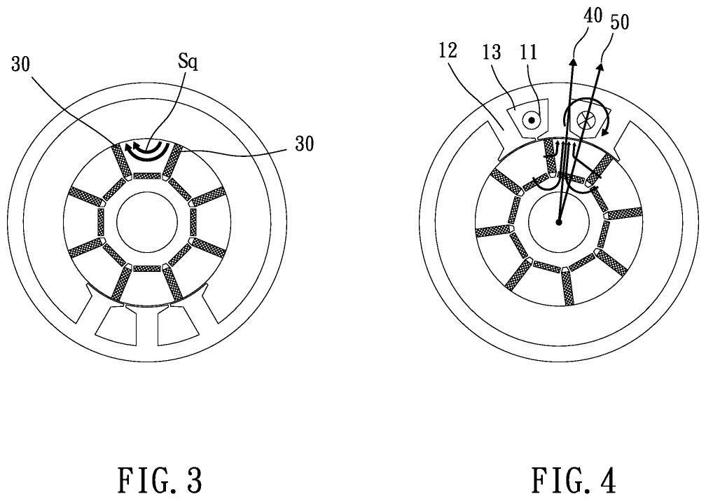

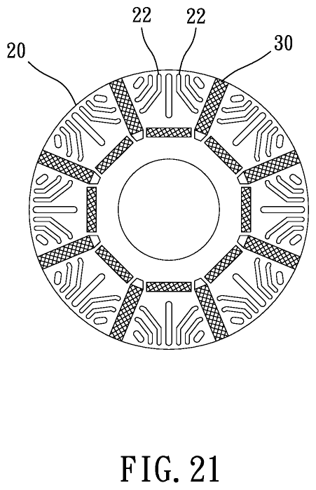

In another embodiment as shown in FIG. 21, the plurality of air gaps 22 are distributed close to the outer periphery of the rotor 20 toward which the d-axis flux path Sd (FIG. 2) directs. For example, ends of the plurality of air gaps 22 are arcuately distributed close to the outer periphery of the rotor 20, which can minimize the armature reaction.

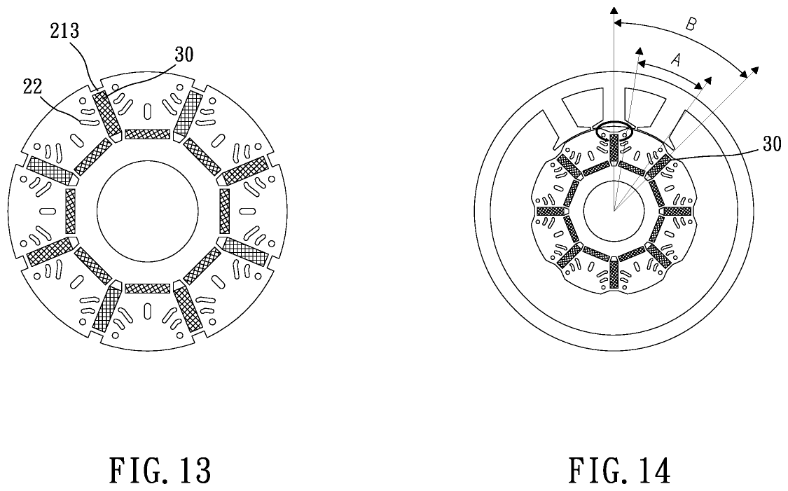

In all embodiments described above, taking FIGS. 5 and 6 as an example, the plurality of air gaps 22 include a straight groove 221 extending along a radial direction of the rotor 20 and a plurality of non-linear grooves 222 which are located at two sides of the straight groove 221. At least one of the plurality of non-linear grooves 222 includes an end segment 223 which is perpendicular to one of the plurality of radial magnet placement slots 212 and a straight segment 224 extending from the end segment 223 toward the radial direction of the rotor 20 so as to define preferable magnetic isolation path and magnetic flux path, which improves output performance and decreases the cogging torque. However, the air gaps may be oblique straight grooves, arc grooves or any other types.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A permanent magnet motor, including:
a stator, having a plurality of windings;
a rotor, having a plurality of magnet placement slots and a plurality of air gaps, the plurality of magnet placement slots including a plurality of circumferential magnet placement slots circumferentially arranged and a plurality of radial magnet placement slots radially extending, the circumferential magnet placement slots and the radial magnet placement slots being circumferentially alternately arranged, the plurality of air gaps being adjacent to a part of the plurality of magnet placement slots and distributed to be on a d-axis flux path of the rotor.

2. The permanent magnet motor of claim 1, wherein the plurality of circumferential magnet placement slots receive a plurality of magnets, and the plurality of radial magnet placement slots are empty.

3. The permanent magnet motor of claim 1, wherein the plurality of radial magnet placement slots receives a plurality of magnets, each of the plurality of magnets in the radial magnet placement slots is located on a q-axis of the rotor, and the plurality of circumferential magnet placement slots are empty.

4. The permanent magnet motor of claim 1, wherein the plurality of magnet placement slots receive a plurality of magnets, at least a part of the plurality of circumferential magnet placement slots receive a part of the plurality of magnets, and at least a part of the plurality of radial magnet placement slots receive a part of the plurality of magnets.

5. The permanent magnet motor of claim 4, wherein the plurality of magnets are different in physical characteristic, and the physical characteristic includes at least one of material, shape and size.

6. The permanent magnet motor of claim 1, wherein the plurality of the magnet placement slots receive a plurality of magnets, and at least one of the magnets has a shape different from a shape of at least one of the magnet placement slots which receives the at least one of the magnets.

7. The permanent magnet motor of claim 1, wherein the plurality of magnet placement slots receive a plurality of magnets, and the plurality of air gaps are distributed close to an outer periphery of the rotor toward which the d-axis flux path directs.

8. The permanent magnet motor of claim 1, wherein the plurality of magnet placement slots receive a plurality of magnets, relative to an outer periphery of the rotor, and the plurality of air gaps are arcuately distributed in conformity with a q-axis flux path of the rotor and radially inwardly concave.

9. The permanent magnet motor of claim 8, wherein the plurality of windings of the stator are capable of being adjustable for current distribution so as to adjust a ratio of a d-axis flux and a q-axis flux entering the rotor.

10. The permanent magnet motor of claim 1, wherein the plurality of radial magnet placement slots receive a plurality of magnets, and outer ends of the plurality of magnets are contracted inwardly relative to an outer periphery of the rotor.

11. The permanent magnet motor of claim 1, wherein the rotor further includes a plurality of rib portions, and each of the rib portions is disposed radially next to an outer end of one of the plurality of radial magnet placement slots.

12. The permanent magnet motor of claim 1, wherein the plurality of magnet placement slots receive a plurality of magnets, and a magnetic pole included angle defined by the plurality of magnets between adjacent two of the plurality of radial magnet placement slots is smaller than a magnetic pole angle defined by two center axes, extending radially, of adjacent two of the plurality of radial magnet placement slots.

13. The permanent magnet motor of claim 1, wherein an outer periphery of the rotor includes a plurality of arc segments, and at least one of the plurality of arc segments and the rotor are eccentric.

14. The permanent magnet motor of claim 1, wherein the plurality of magnet placement slots receive a plurality of magnets, and an outer periphery of the rotor has a retracted surface near a d-axis of the rotor.

15. The permanent magnet motor of claim 1, wherein the rotor further includes a plurality of second magnet placement slots which are disposed between some of adjacent two of the plurality of radial magnet placement slots.

16. The permanent magnet motor of claim 15, wherein at least one of the plurality of second magnet placement slots receives at least one magnet.

17. The permanent magnet motor of claim 1, wherein the plurality of air gaps include a straight groove extending along a radial direction of the rotor and a plurality of non-linear grooves which are located at two sides of the straight groove, at least one of the plurality of non-linear grooves includes an end segment which is perpendicular to one of the plurality of radial magnet placement slots and a straight segment extending from the end segment toward the radial direction of the rotor.

18. The permanent magnet motor of claim 1, wherein at least one of the plurality of radial magnet placement slots extends and terminates between two end surfaces, facing each other, of adjacent two of the plurality of circumferential magnet placement slots, and along a circumferential direction of the rotor, the two end surfaces entirely within the radial magnet placement slot between the two end surfaces.
